(19) United States
(12) Patent Application Publication
(10) Pub. No.: US 2004/0114522 A1
(43) Pub. Date: Jun. 17, 2004

(54) Efficient non-user data transmission method

(75) Inventors: Larry Friesen, Nepean (CA); Robert John Johnson, Ottawa (CA); Jason Sterne, Ottawa (CA); James Michael Schriel, Nepean (CA); Dion Pike, Dunrobin (CA)

Correspondence Address: John Granchelli, Alcatel Canada Inc., 600 March Road, Ottawa, ON, K2K 2E6, CA

(73) Assignee: ALCATEL CANADA INC., Kanata (CA)

(21) Appl. No.: 10/316,946

(22) Filed: Dec. 12, 2002

(51) Int. Cl. H04L 1/00

(52) U.S. Cl. 370/241

(57) ABSTRACT

The method described herein is a more efficient way to transmit non-user data over a SPI 4.2 interface. During single PHY mode, the transmission occurs between single ports, eliminating the need for a port address in the control word portion of the SPI 4.2 data word. Consequently, the address bits can be used to indicate the type of data being transmitted in single PHY mode, either user or non-user data. Since non-user data is transmitted periodically, the bandwidth granularity is improved by using bandwidth when required for the non-user data as opposed to dedicating bandwidth to it. The bandwidth granularity is reduced to remain within the specifications for any type of SPI 4.2 packet, including OC-192.

### BACKGROUND OF THE INVENTION

1. Field of the Invention

This invention relates to an improved method of transmitting non-user data from a “packet over SONET” (known as POS) port via a SPI 4.2 interface to a network processor on a POS card. The SPI 4.2 protocol is defined as both “Implementation Agreement OIF-SPI4-02.0” by the Optical Internetworking Forum and “POS-PHY Level 4” by Saturn Group.

2. Background Information

High speed data transmission, such as POS, requires an interface between the physical layer and the link layer. The SPI 4.2 protocol is a system packet interface created by the Optical Internetworking Forum (OWF).

In the prior art system shown in FIG. 1, a pair of OC-192 I/O cards 10 in a 1+1 protection configuration are coupled to an OC-192 POS card 11 via a midplane 12 in a switching system. Each I/O card has a framer 13 for receiving an OC-192 SONET signal and translating the data received in the signal into data words defined by the SPI 4.2 interface protocol. The data words go through the midplane, which is supported by proprietary custom interface ICs 14 on the I/O cards and the POS card. From the POS card, the network processor 15 receives the SPI 4.2 formatted data words, processes them and forwards the processed data words to a switching fabric of a switching system.

As is shown in FIG. 1, the SPI 4.2 interface must incorporate non-user data, such as framing bits from the framer and diagnostic data from the POS card, into the data path of SPI 4.2 data word traffic flowing to the POS card, without adversely affecting the bandwidth granularity. The SPI 4.2 protocol does not specifically provide a means of transmitting this non-user data in the data path. One way of doing this has been to assign the non-user data to a “virtual” port and operate in multi-PHY (Physical device) mode which uses an address field as a port indicator. However, not only does this contradict the architecture of the system since it has only one PHY device per port, but the finest bandwidth granularity that can be achieved with this method is insufficient for OC-192 transmission standards. Since the data streams are assumed to be a combination of low bandwidth and high bandwidth streams, to achieve bandwidth granularity the low bandwidth streams must receive high priority treatment under the assumption that they are rate limited.

### SUMMARY OF THE INVENTION

The invention provides a means of transmitting non-user data over a SPI 4.2 interface at any bandwidth granularity. The address bits of the control word portion of a SPI 4.2 data word are set to indicate the type of data being transmitted during single PHY mode. Since non-user data is transmitted periodically, the bandwidth granularity is improved by using bandwidth only when required for the non-user data as opposed to dedicating bandwidth to the non-user data.

### BRIEF DESCRIPTION OF THE DRAWINGS

FIG. 1 is a block diagram of a prior art data transmission system using POS cards and the SPI 4.2 protocol,

FIG. 2 shows the format of the SPI 4.2 data word.

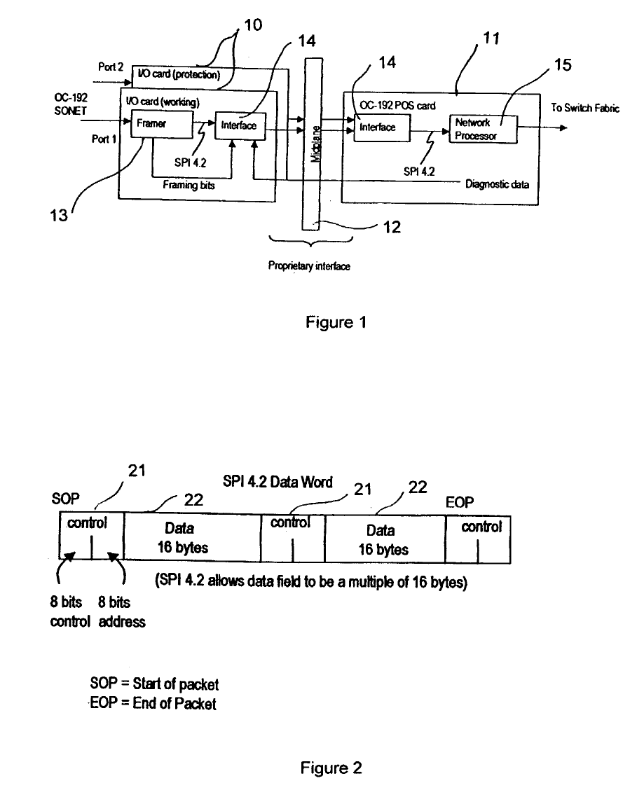

### DESCRIPTION OF THE PREFERRED EMBODIMENT

Referring to FIG. 2, the SPI 4.2 protocol provides for a data word format with data portions 22 that are multiples of 16 bytes in length bracketed on either end by control word portions 21 having 8-bit address and control fields. The SPI 4.2 protocol can be used in single PHY (Physical device) or multi-PHY mode. In single PHY mode the address field is not used for bandwidth allocation. When used in multi-PHY mode with a multi-port interface, the address field is used for denoting to which port the data word belongs. The finest bandwidth granularity that can be obtained by the multi-PHY mode is 1/256 or 0.4% of the line rate since the control word portion has a maximum of 8 address bits. However, the bandwidth granularity required for the OC-192 POS application is smaller, being less than 0.1% of the line rate.

Even if the SPI 4.2 interface was operated in the multi-PHY mode, contrary to the architecture of the system since it has only one PHY device per port, the bandwidth granularity would not be sufficient for non-user data.

This invention relates to a modification made to the address field in the control word portion of the SPI 4.2 data word when operating in single PHY mode. Specifically, the address field is used to identify the type of data within the data portion of the SPI 4.2 data word. This allows non-user data of the POS application to be carried in-band with an arbitrarily small amount of bandwidth granularity. With respect to the POS application, the address field can be used to indicate any one of the following types of data:

a) 10 Gbps user data

b) SONET DCC from port 1

c) SONET DCC from port 2

d) diagnostics from I/O card 1

e) diagnostics from I/O card 2

The data types of b) to e) represent non-user data that is sent as required, indicating there is no bandwidth pre-assigned to these types as with the ports of the multi-PHY mode. Consequently the bandwidth granularity possible for non-user data can be arbitrarily small.

Thus, an improved method of transmitting the non-user data of a POS application has been disclosed while operating within the limits set by the SPI 4.2 protocol.

1. A method for transmission of data between first and second devices over a system constrained by a protocol established for data word traffic including the provision for address bits, comprising the steps of:
operating the protocol with a single physical device,
determining to which data type, of a predetermined group of data types, the data portion belongs,
inserting a control word having an indication of the data type prior to the data portion, and
transmitting the data portions and the control words from the first device,
which includes a switching fabric, to the second device, which includes a network processor.

2. The method according to claim 1 wherein the protocol is SPI 4.2.

3. The method according to claim 2 wherein the control word includes an address field which indicates the type of data.

4. The method of claim 2 wherein one of the data types is non-user data.

5. The method of claim 4 wherein the non-user data includes one of control, diagnostic and maintenance data.

6. The method of claim 2 wherein the second device receives the data word and determines the type of data in the data portion of the data word and processes the data portions accordingly.
